(19) United States
(12) Patent Application Publication
(10) Pub. No.: US 2023/0031425 A1
(43) Pub. Date: Feb. 2, 2023

(54) METHODOLOGY TO ESTIMATE SLOT LINE DIRECTION FOR PARKING SLOT DETECTION

(71) Applicant: DUS Operating Inc,, Auburn Hills, MI (US)

(72) Inventors: Jyothendra Varma Venkata Rama Kota Polisetty, Vijayawada (IN); Chokkarapu Anil, Warangal (IN); Avinash Bojja Venkata, Nagpur (IN); Ashwary Kaushik, Gurgaon (FR); Aravind Phani Kumar Mannava, Mansoorabad (IN)

(21) Appl. No.: 17/391,563

(22) Filed: Aug. 2, 2021

(51) Int. Cl. B60W 30/06; G06K 9/00; G06K 9/46; G06T 7/60; G06T 7/73; H04N 5/247; G05D 1/02

(52) U.S. Cl. CPC B60W 30/06; G06K 9/00812; G06K 9/4604; G06T 7/60; G06T 7/73; H04N 5/247; G05D 1/0246; G05D 1/0225; G06T 2207/30264; G06T 2207/20164; G06T 2207/20084; B60W 60/001

(57) ABSTRACT

An Automated Parking System (“APS”) for a motor vehicle includes a plurality of cameras for generating a vision signal, in response to the cameras capturing an image of a region surrounding the motor vehicle. The APS includes a processor for receiving the vision signal from the cameras. The APS further includes a non-transitory computer readable storage medium for storing instructions such that the processor is programmed to execute a plurality of routines. The routines include a detection module for detecting one or more landmark points in the image. The routines further include an estimate slot module for determining one or more corners of a parking slot based on the landmark points. The routines further include a maneuver module for generating an action signal, with a power steering system maneuvering the motor vehicle into the parking slot based on the corners.

### FIELD

The present disclosure relates to Advanced Driver Assistance Systems for motor vehicles, and more particularly, to a method and system for detecting a parking slot and maneuvering the motor vehicle into the parking slot.

### BACKGROUND

Modern vehicles with Advanced Driver Assistance Systems (“ADAS”) can have an Automatic Park Assistance feature for receiving signals from transceivers and other components integrated within infrastructure, such that the systems can detect a size and location of a parking slot relative to the vehicle. These systems can include one or more cameras mounted on the vehicle for capturing images of a parking slot where a driver intends to park the vehicle. These systems can use a neural network for determining whether all the markings in the images are associated with the dimensions of an entire parking slot that can accommodate the vehicle. However, this can require high computational speed from the processor. Another drawback is that an insufficient number of markings of the target parking slot may be detected by the system, such that the system does not have sufficient input data for accurately detecting the parking slot. Put another way, these systems may estimate the target parking slot without detecting or considering the markings of parking slots that are adjacent to the target parking slot.

Accordingly, there is a need for a new and improved Automated Parking System for a motor vehicle that addresses these issues.

### SUMMARY

According to several aspects, an Automated Parking System (“APS”) for a motor vehicle includes a plurality of cameras mounted to the motor vehicle for generating a plurality of vision signals, in response to the cameras capturing a plurality of images of an associated plurality of regions surrounding the motor vehicle. The APS further includes one or more processors electrically connected to the cameras for receiving the associated vision signals from the cameras. The APS further includes a non-transitory computer readable storage medium (“CRM”) electrically connected to the processor. The CRM stores instructions, such that the processor is programmed to execute a plurality of routines. The routines include a detection module of a trained deep neural network, which when executed by the processor, detects one or more landmark points in one or more of the images. The routines further include an estimate slot module, which when executed by the processor, determines one or more corners associated with a parking slot based on the landmark points. The routines further include a maneuver module, which when executed by the processor, generates one or more action signals for maneuvering the motor vehicle into the parking slot based on the corners. The APS further includes a power steering system electrically connected to the processor and steering the motor vehicle into the parking slot, in response to the power steering system receiving the action signal from the processor.

In one aspect, the processor executes the detection module for detecting three or more of the landmark points. The processor executes the estimate slot module for determining three or more reference lines based on the landmark points. Each reference line extends between one of the landmark points and an associated one of the other landmark points, and two or more of the reference lines intersect one another. The processor further executes the estimate slot module for determining a tilt of each reference line and an angle that spaces each pair of intersecting reference lines. The processor further executes the estimate slot module for comparing the angle to a range of parking slot angles. The processor further executes the estimate slot module for determining that the associated landmark point, where two of the reference lines intersect one another, is a corner of a parking slot, in response to the processor determining that the angle associated with the landmark point is within the range of parking slot angles.

In another aspect, the processor further executes the detection module for determining a shape of the parking slot. The processor further executes the detection module for determining the range of parking slot angles based on the shape. The range of parking slot angles is indicated in an angle reference lookup table that is stored in the CRM.

In another aspect, the angle reference lookup table indicates that the range of parking slot angles is between 40 and 65 degrees and between 115 and 140 degrees, in response to the processor determining that the shape of the parking slot is a parallelogram.

In another aspect, the angle reference lookup table indicates that the range of parking slot angles is between 85 and 95 degrees, in response to the processor determining that the shape of the parking slot is a rectangle.

In another aspect, the processor further executes the estimate slot module for determining a distance between each landmark point and an associated one of the other landmark points. The processor further executes the estimate slot module for comparing the distance to a range of parking slot dimensions. The range of parking slot dimensions is indicated in a distance reference lookup table that is stored in the CRM. The processor further executes the estimate slot for determining that the landmark point, where two of the reference lines intersect one another, is a corner of the parking slot, in further response to the processor determining that the distance is within the range of parking slot dimensions.

In another aspect, the processor further executes the estimate slot module for determining an image coordinate for each landmark point in the image and converting the image coordinate to a vehicle coordinate relative to the motor vehicle.

In another aspect, the processor further executes the maneuver module for generating the action signal based on the vehicle coordinate.

According to several aspects, a non-transitory computer readable storage medium (“CRM”) is provided for an Automated Parking System (“APS”) of a motor vehicle. The CRM is electrically connected to one or more processors and stores instructions, such that the processor is programmed to execute a plurality of routines. The routines include a detection module of a trained deep neural network, which when executed by the processor, detects one or more landmark points in one or more of the images. The routines further include an estimate slot module, which when executed by the processor, determines one or more corners associated with a parking slot based on one or more landmark points. The routines further include a maneuver module, which when executed by the processor, generates one or more action signals for maneuvering the motor vehicle into the parking slot based on the corner.

In one aspect, the processor further executes the detection module for detecting three or more landmark points. The processor further executes the estimate slot module for determining three or more reference lines. Each reference line extends between one of the landmark points and an associated one of the other landmark points, with two of the reference lines intersecting one another. The processor further executes the estimate slot module for determining a tilt of each reference line and an angle that spaces each pair of intersecting reference lines. The processor further executes the estimate slot module for comparing the angle to a range of parking slot angles. The processor further executes the estimate slot module for determining that the associated landmark point, where two of the reference lines intersect one another, is a corner of a parking slot, in response to the processor determining that the angle associated with the landmark point is within the range of parking slot angles.

In another aspect, the processor further executes the detection module for determining a shape of the parking slot. The processor further executes the detection module for determining the range of parking slot angles based on the shape, with the range of parking slot angles being indicated in an angle reference lookup table that is stored in the CRM.

In another aspect, the angle reference lookup table indicates that the range of parking slot angles is between 40 and 65 degrees and between 115 and 140 degrees, in response to the processor determining that the shape of the parking slot is a parallelogram.

In another aspect, the angle reference lookup table indicates that the range of parking slot angles is between 85 and 95 degrees, in response to the processor determining that the shape of the parking slot is a rectangle.

In another aspect, the processor further executes the estimate slot module for determining a distance between each landmark point and an associated one of the other landmark points. The processor further executes the estimate slot module for comparing the distance to a range of parking slot dimensions, with the range of parking slot dimensions being indicated in a distance reference lookup table that is stored in the CRM. The processor further executes the estimate slot module for determining that the landmark point, where two of the reference lines intersect one another, is a corner of the parking slot, in further response to the processor determining that the distance is within the range of parking slot dimensions.

In another aspect, the processor further executes the estimate slot module for determining an image coordinate for each landmark point in the image and converting the image coordinate to a vehicle coordinate relative to the motor vehicle.

In another aspect, the processor further executes the maneuver module for generating the action signal based on the vehicle coordinate.

According to several aspects, a process is provided for operating an Automated Parking System (“APS”) for a motor vehicle. The APS includes a plurality of cameras mounted to the motor vehicle and a non-transitory computer readable storage medium (“CRM”), which is electrically connected to one or more processors and stores instructions. The process includes the cameras generating a plurality of vision signals, in response to the cameras capturing a plurality of images of an associated plurality of regions surrounding the motor vehicle. The processor receives the vision signals from the associated cameras. The processor executes a detection module for detecting one or more landmark points in one or more of the images based on the vision signals. The processor executes an estimate slot module for determining one or more corners associated with a parking slot based on one or more of the landmark points. The processor executes a maneuver module for generating one or more action signals for maneuvering the motor vehicle into the parking slot based on the corners. The power steering system steers the motor vehicle into the parking slot, in response to the power steering system receiving the action signal from the processor.

In one aspect, the processor further executes the detection module for detecting three or more landmark points. The processor further executes the estimate slot module for determining three or more reference lines, with each of the reference lines extending between one of the landmark points and an associated one of the other landmark points. Two or more of the reference lines intersect one another. The processor further executes the estimate slot module for determining a tilt of each of the reference lines and an angle that spaces each pair of intersecting reference lines. The processor executes the estimate slot module for comparing the angle to a range of parking slot angles. The processor further executes the estimate slot module for determining that the associated landmark point, where two of the reference lines intersect one another, is a corner of a parking slot, in response to the processor determining that the angle associated with the landmark point is within the range of parking slot angles.

In another aspect, the processor further executes the detection module for determining a shape of the parking slot and determining the range of parking slot angles based on the shape. The range of parking slot angles is indicated in an angle reference lookup table that is stored in the CRM.

In another aspect, the processor further executes the estimate slot module for determining a distance between each landmark point and an associated one of the other landmark points. The processor further executes the estimate slot module for comparing the distance to a range of parking slot dimensions. The range of parking slot dimensions is indicated in a distance reference lookup table that is stored in the CRM. The processor executes the estimate slot module for determining that the landmark point, where two of the reference lines intersect one another, is a corner of the parking slot, in further response to the processor determining that the distance is within the range of parking slot dimensions.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a diagram of one example of a motor vehicle having an Automated Park System with a non-transitory computer readable storage medium and a processor for executing multiple routines to detect a parking slot that has a rectangular shape.

FIG. 2 is a diagram of the motor vehicle of FIG. 1, illustrating the Automated Park System with the non-transitory computer readable storage medium and the processor executing multiple routines to detect a parking slot that has an open parallelogram shape.

FIG. 3 is a diagram of a deep neural network loaded in the non-transitory computer readable storage medium of FIG. 1.

FIG. 4 is a flow chart illustrating one example of a process for operating the non-transitory computer readable storage medium of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

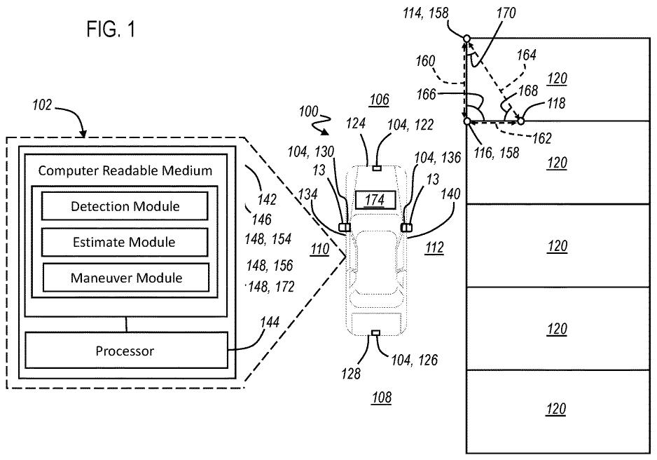

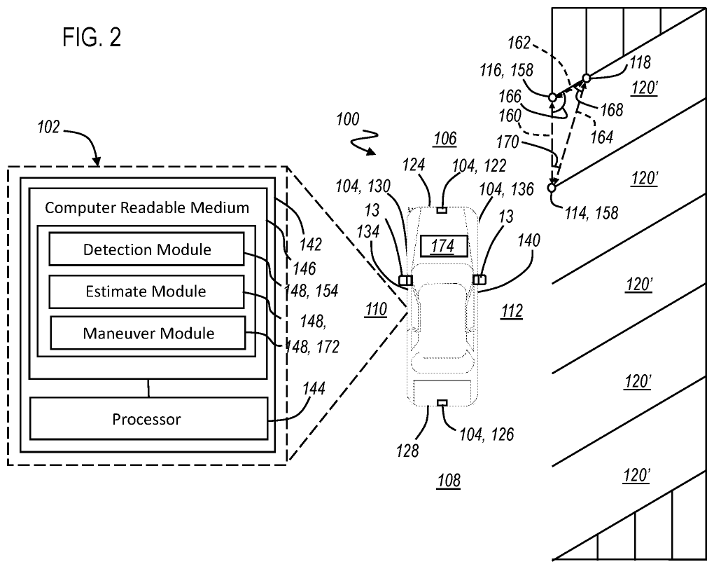

Referring to FIGS. 1 and 2, one non-limiting example of a motor vehicle 100 includes an Automated Parking System 102 (“APS”) for identifying one or more parking slots and maneuvering the motor vehicle 100 into a selected one of the parking slots. The motor vehicle 100 is a land vehicle, such as a car, truck or the like. As described in detail below, the APS 102 includes a plurality of wide-angle lens cameras 104 mounted to the motor vehicle 100 for generating visional signals, in response to the cameras 104 capturing images of the associated regions 106, 108, 110, 112 surrounding the motor vehicle 100. The APS 102 uses a trained deep neural network for the limited functions consisting of detecting one or more landmark points 114, 116, 118, and shapes in the images. These limited functions can minimize computational processing using the neural network. In this example, the APS 1012 executes an algorithm to identify one or more parking slots 120 based on the landmark points 114, 116, 118 and the shapes. FIG. 1 illustrates the APS 102 identifying one or more parking slots 120 that have a closed rectangular shape, and FIG. 2 illustrates the APS 102 identifying one or more parking slots 120′ that have an open parallelogram shape. While this non-limiting example of the APS 102 detects parking slots 120, 120′ having associated closed rectangular shapes and open parallelogram shapes, it is contemplated that the APS 102 can identify parking slots having open rectangular shapes, closed parallelogram shapes, or any other suitable shape.

In this non-limiting example, the APS 102 includes four wide-angle lens cameras 104. The cameras 104 include a first camera 122 mounted to a front end 124 of the motor vehicle 100, with the first camera 122 facing forward and downward from the front end 124 of the motor vehicle 100. The cameras 104 further include a second camera 126 mounted to a rear end 128 of the motor vehicle 100, with the second camera 126 facing rearward and downward from the rear end 128 of the motor vehicle 100. The cameras 104 further include a third camera 130 mounted to a first sideview mirror 132 on a driver side 134 of the motor vehicle 100, with the third camera 130 facing outward and downward from the driver side 134 of the motor vehicle 100. The cameras 104 further include a fourth camera 136 mounted to a second sideview mirror 138 on a passenger side 140 of the motor vehicle 100, with the fourth camera 136 facing outward and downward from the passenger side 140 of the motor vehicle 100. Each of the first, second, third, and fourth cameras 122, 126, 130, 136 can have a 135-degree field of view. In other non-limiting examples, the APS 102 can include two, six, or any suitable number of cameras mounted to any portion of the vehicle, e.g., a rear view mirror, a third brake light, and the like, with any suitable field of view.

The APS 102 includes a computer 142 for operating the motor vehicle 100 in an autonomous, a semi-autonomous mode, or a non-autonomous (manual) mode. For purposes of this disclosure, an autonomous mode is defined as one in which each of the vehicle's propulsion, braking, and steering are controlled by the computer 142; in a semi-autonomous mode the computer 142 controls one or two of the vehicle's propulsion, braking, and steering; in a non-autonomous mode a human operator controls each of the vehicle's propulsion, braking, and steering. The computer 142 may include or be communicatively coupled to, e.g., via a vehicle communications module as described further below, more than one processor, e.g., included in electronic controller units (ECUs) or the like included in the vehicle for monitoring and/or controlling various vehicle components, e.g., a powertrain controller, a brake controller, a steering controller, etc. Further, the computer 142 may communicate, via the vehicle communications module, with a navigation system that uses the Global Position System (GPS). As an example, the computer 142 may request and receive location data of the vehicle. The location data may be in a known form, e.g., geo-coordinates (latitudinal and longitudinal coordinates). The computer 142 is generally arranged for communications on the vehicle 105 communications module and also with a vehicle internal wired and/or wireless network, e.g., a bus or the like in the vehicle such as a controller area network (CAN) or the like, and/or other wired and/or wireless mechanisms.

Via the vehicle communications network, the computer 142 may transmit signals to various devices in the vehicle 100 and/or receive signals from the various devices, e.g., vehicle sensors, actuators, vehicle components, a human machine interface (HMI), etc. Alternatively or additionally, in cases where the computer 142 includes a plurality of devices, the vehicle communications network may be used for communication between devices represented as the computer 142 in this disclosure. Further, as mentioned below, various processors and/or vehicle sensors may provide data to the computer 142.

The vehicle's actuators are implemented via circuits, chips, motors, or other electronic and or mechanical components that can actuate various vehicle subsystems in accordance with appropriate control signals as is known. The actuators may be used to control components, including braking, acceleration, and steering of a vehicle 100. In the context of the present disclosure, a vehicle component is one or more hardware components adapted to perform a mechanical or electro-mechanical function or operation—such as moving the vehicle 100, slowing or stopping the vehicle 100, steering the vehicle 100, etc. Non-limiting examples of components include a propulsion component (that includes, e.g., an internal combustion engine and/or an electric motor, hydrogen fuel cell, etc.), a transmission component, a steering component (e.g., that may include one or more of a steering wheel, a steering rack, etc.), and a brake component (as described below).

The computer 142 includes one or more processors 144 electrically connected to the cameras 104, by wired or wireless connection, for receiving the associated vision signals from the cameras 104. The computer 142 further includes a non-transitory computer readable storage medium 146 (“CRM”) electrically connected to the processor 144. The CRM 146 stores instructions such that the processor 144 is programmed to execute a plurality of routines 148. In this non-limiting example, the processor 144 executes a detection module 154 in a trained deep neural network (“DNN”) for detecting three landmark points 114, 116, 118. However, it is contemplated that the processor 144 can execute the detection module 154 for detecting more or fewer than three landmark points. The processor 144 is configured to determine an image coordinate for each landmark point in the image and convert the image coordinate to a vehicle coordinate relative to the motor vehicle 100.

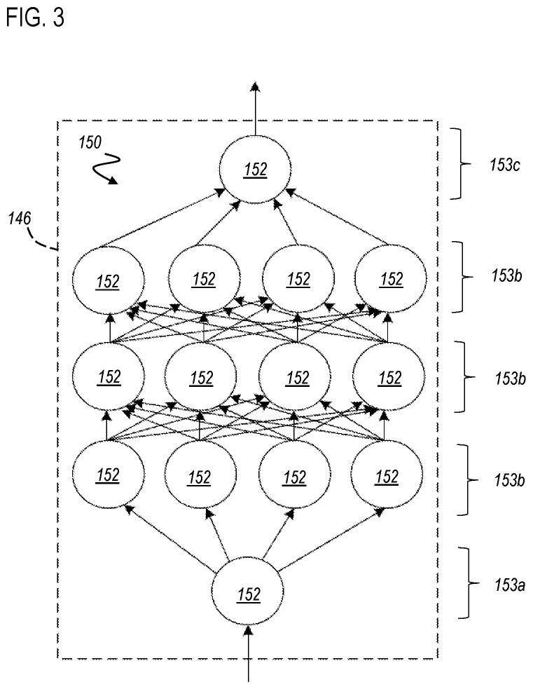

As shown in FIG. 3, a diagram of one example of a deep neural network (DNN) 150 can be a software program loaded in the CRM 146 and executed by the processor 144 (FIGS. 1 and 2) included in the computer 142. In this example, the DNN 150 can include any suitable neural network capable of employing reinforcement learning techniques. For example, the DNN 150 may be a convolutional neural network. The DNN 150 includes multiple neurons 152, and the neurons 152 are arranged so that the DNN 150 includes an input layer 153a, one or more hidden layers 153b, and an output layer 153c. Each layer of the DNN 150 can include a plurality of neurons 152. While FIG. 3 illustrates three (3) hidden layers 153b, it is understood that the DNN 150 can include additional or fewer hidden layers. The input and output layers 153a, 153c may also include more than one (1) neuron 152.

The neurons 152 are sometimes referred to as artificial neurons 152, because they are designed to emulate biological, e.g., human, neurons. A set of inputs (represented by the arrows) to each neuron 152 are each multiplied by respective weights. The weighted inputs can then be summed in an input function to provide, possibly adjusted by a bias, a net input. The net input can then be provided to activation function, which in turn provides a connected neuron 152 an output. The activation function can be a variety of suitable functions, typically selected based on empirical analysis. As illustrated by the arrows in FIG. 3, neuron 152 outputs can then be provided for inclusion in a set of inputs to one or more neurons 152 in a next layer.

The DNN 150 can be trained to accept sensor data, e.g., from the vehicle CAN bus or other network, as input and generate a state-action value, e.g., reward value, based on the input. The DNN 150 can be trained with training data, e.g., a known set of sensor inputs, to train the agent for the purposes of determining an optimal policy. In one or more implementations, the DNN 150 is trained via a server (not shown), and the trained DNN 150 can be transmitted to the vehicle 100 via a network (not shown), e.g., during a design phase of the vehicle. Weights can be initialized by using a Gaussian distribution, for example, and a bias for each neuron 152 can be set to zero. Training the DNN 150 can include updating weights and biases via suitable techniques such as back-propagation with optimizations.

During operation, the computer 142 obtains sensor data from the sensors, e.g. the cameras 104, and provides the data as input to the DNN 150. Once trained, the DNN 150 can accept the sensor input and provide, as output, one or more state-action values (Q-values) based on the sensed input. During execution of the DNN 150, the state-action values can be generated for each action available to the agent within the environment.

Referring back to FIGS. 1 and 2, the processor 144 executes the detection module 154 in the trained DNN for determining a shape of the parking slot 120 and determining the range of parking slot angles based on the shape. The range of parking slot angles is indicated in an angle reference lookup table that is stored in the CRM 146. The reference lookup table can indicate that the range of parking slot angles is between 85 and 95 degrees, in response to the processor 144 determining that the shape of the parking slot 120 is a closed rectangular shape (FIG. 1). The angle reference lookup table can indicate that the range of parking slot angles is between 40 and 65 degrees and between 115 and 140 degrees, in response to the processor 144 determining that the shape of the parking slot 120′ is an open parallelogram shape (FIG. 2). However, it is contemplated that the range of parking slot angles can be any other suitable ranges of angles.

In this non-limiting example, the routines 148 further include an estimate slot module 156, which when executed by the processor 144, determines one or more corners 158 associated with a parking slot based on the landmark points 114, 116, 118. More specifically, the processor 144 executes the estimate slot module 156 for determining a plurality of reference lines, with each reference line extending between one of the landmark points and an associated one of the other landmark points. Continuing with the previous example where the processor 144 has detected three landmark points 114, 116, 118, the processor 144 executes the estimate slot module 156 for determining a first reference line 160 that extends between the first and second landmark points 114, 116, a second reference line 162 that extends between the second and third landmark points 116, 118, and a third reference line 164 that extends between the first and third landmark points 114, 118. At least two of the reference lines intersect one another. In this example, first and second reference lines 160, 162 intersect one another. The processor 144 further executes the estimate slot module 156 for determining a tilt of each of the reference lines according to Equations 1, 2, and 3:

tilt=a tan 2((P_{1y}−P_{2y}),(P₂ₓ−P₁ₓ)) Eqn. 1

tilt=a tan 2((P_{2y}−P_{3y}),(P₃ₓ−P₂ₓ)) Eqn. 2

tilt=a tan 2((P₁ₓ−P₃ₓ),(P_{3y}−P_{1y})) Eqn. 3

wherein P_{1y} and P₁ₓ represent an associated one of a y-coordinate and an x-coordinate of the first landmark point 114. In addition, P_{2y} and P₂ₓ represent an associated one of a y-coordinate and an x-coordinate of the second landmark point 116. Furthermore, P_{3y} and P₃ₓ represent an associated one of a y-coordinate and an x-coordinate of the third landmark point 118.

In another example (not shown) where four landmark points are detected and four reference lines reference lines are determined, the processor 144 executes the estimate slot module for determining a tilt of each of the reference lines according to Equations 4, 5, 6, and 7:

tilt=a tan 2((P_{1y}−P_{2y}),(P₂ₓ−P₁ₓ)) Eqn. 4

tilt=a tan 2((P_{2y}−P_{4y}),(P₄ₓ−P₃ₓ)) Eqn. 5

tilt=a tan 2((P₁ₓ−P₃ₓ),(P_{1y}−P_{3y})) Eqn. 6

tilt=a tan 2((P₂ₓ−P₄ₓ),(P_{2y}−P_{4y})) Eqn. 7

wherein P_{1y} and P₁ₓ represent an associated one of a y-coordinate and an x-coordinate of a first landmark point. In addition, P_{2y} and P₂ₓ represent an associated one of a y-coordinate and an x-coordinate of a second landmark point. Furthermore, P_{3y} and P₃ₓ represent an associated one of a y-coordinate and an x-coordinate of a third landmark point. P_{4y} and P₄ₓ represent an associated one of a y-coordinate and an x-coordinate of a fourth landmark point.

As described below, the processor 144 determines that the associated landmark point, where two of the reference lines intersect one another, is a corner of a parking slot, in response to the processor 144 determining that the angle associated with the landmark point is within the range of parking slot angles and the distance between the two landmark points is within the range of parking slot dimensions. The processor 144 further executes the estimate slot module 156 for determining an angle that spaces each pair of reference lines that intersect one another. Continuing with the previous example illustrated in FIG. 1, the processor 144 determines that first and second reference lines 160, 162 are angularly spaced from one another by a first angle 166, namely ninety (90) degrees. The processor 144 further determines that second and third reference lines 162, 164 are angularly spaced from one another by a second angle 168, namely sixty (60) degrees. The processor 144 further determines that first and third reference lines 160, 164 are angularly spaced from one another by a third angle 170, namely thirty (30) degrees.

The processor 144 compares each angle between each pair of intersecting reference lines to the range of parking slot angles, as a first condition to determining whether the detected landmark points are associated with a parking slot. Continuing with the previous example, the processor 144 determines that the first angle 166, namely ninety (90) degrees, is within the angular range of eighty-five (85) to ninety-five (95) degrees associated with the parking slot 120 having the closed rectangular shape. The processor 144 determines that the second angle 168, namely sixty (60) degrees, is not within the angular range of eighty-five (85) to ninety-five (95) degrees, and the third angle 170, namely 30 degrees, is not within the angular range of eighty-five (85) to ninety-five (95) degrees.

The processor 144 executes the estimate slot module 156 for determining a distance between each landmark point and an associated one of the other landmark points. The processor 144 executes the estimate slot module 156 for comparing the distance to a range of parking slot dimensions, as a second condition to determining whether the detected landmark points are associated with a parking slot. The range of parking slot dimensions is indicated in a distance reference lookup table that is stored in the CRM 146. The processor 144 determines that the landmark point, where two of the reference lines intersect one another, is the location of a corner of the parking slot, in further response to the processor 144 determining that the distance is within the range of parking slot dimensions. In one non-limiting example, the reference lookup table can indicate that the range of parking slot dimensions is between 7.5 and 9 feet. However, it is contemplated that the range of parking slot dimensions can be any other suitable ranges of distances.

Continuing with the previous example, the processor 144 determines that the second landmark 116 is a corner 158 of a parking slot 120 (FIG. 1), in response to the processor 144 determining that the first angle 166, namely ninety (90) degrees, is within the range of parking slot angles, e.g., between eighty-five (85) to ninety-five (95) degrees, and the processor 144 further determining that the distance between the first and second landmark points 114, 116 is within the range of parking slot dimensions, e.g., between 7.5 and 9 feet. The processor 144 determines that the first landmark 114 is not a corner of the parking slot 120 (FIG. 1), in response to the processor 144 determining that the third angle 170, namely thirty (30) degrees, is not within the range of parking slot angles, e.g., between eighty-five (85) to ninety-five (95) degrees. However, the processor 144 may determine that the first landmark 114 is a corner of a parking slot 120 (FIG. 1), in response to the processor 144 determining that the distance between the first and second landmark points 114, 116 is within the range of parking slot dimensions, e.g., between 7.5 and 9 feet and the processor 144 determining that the shape of the parking slot is rectangular. The processor 144 determines that the third landmark 118 is not a corner of the parking slot 120 (FIG. 1), 120′ (FIG. 2), in response to the processor 144 determining that the second angle 168, namely thirty (30) degrees, is not within the range of parking slot angles, e.g., between eighty-five (85) to ninety-five (95) degrees and the processor 144 further determining that the distance between the second and third landmark points 116, 118 is not within the range of parking slot dimensions, e.g., between 7.5 and 9 feet.

In this non-limiting example, the routines 148 further include a maneuver module 172. The processor 144 executes the maneuver module 172 for generating one or more action signals to maneuver the motor vehicle 100 into the parking slot 120 based on: one or more corners 158 of the parking slot 120 where the driver intends to park the vehicle 100; the corners of one or more parking slots adjacent to the target parking slot 120; and/or the shape of the target parking slot or the parking slots adjacent to the target parking slot 120. The processor 144 further executes the maneuver module 172 for generating one or more action signals relative to the vehicle coordinate.

The APS 102 further includes a power steering system 174 electrically connected to the processor 144. The power steering system 174 steers the motor vehicle 100 into the parking slot 120, in response to the power steering system 174 receiving the action signal from the processor 144.

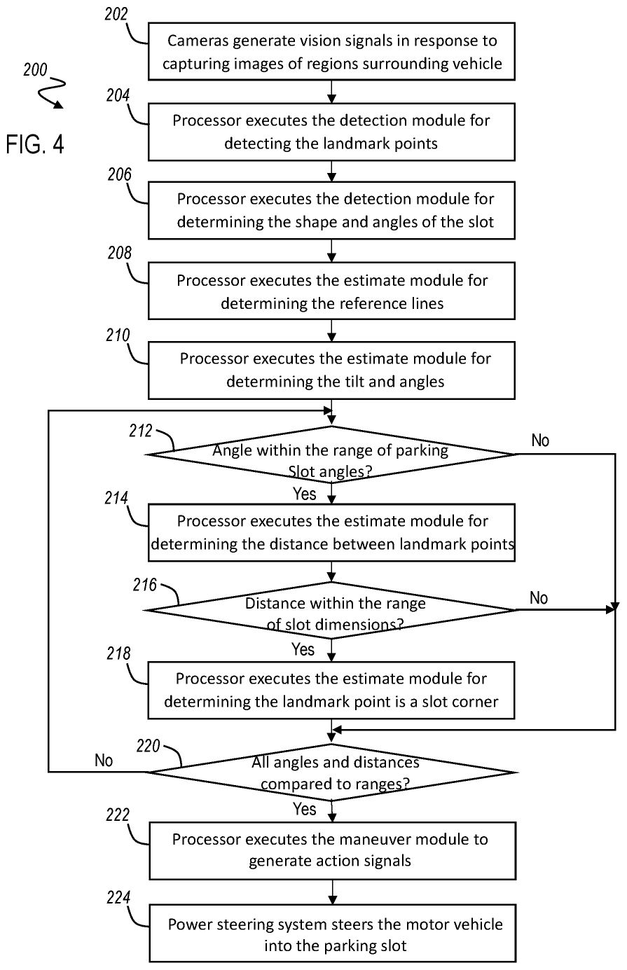

Referring to FIG. 4, one example of a process 200 of operating the APS 102 of the motor vehicle 100 illustrated in FIGS. 1 and 2 is provided. The process 200 begins at block 202 with the cameras 104 generating the vision signals, in response to the cameras 104 capturing the images of the associated regions surrounding the motor vehicle 100.

At block 204, the processor 144 receives the vision signals from the associated cameras and executes the detection module 154 for detecting one or more landmark points 114, 116, 118 in the images, such that the processor 144 determines one or more corners associated with the parking slot based on the landmark point. More specifically, the processor 144 executes the detection module 154 in the trained deep neural network for detecting one or more landmark points in at least one of the images. In this example, the processor 144 executes the detection module 154 in the trained deep neural network for detecting three landmark points 114, 116, 118. However, the processor 144 can execute the detection module for detecting more or fewer than three landmark points. The processor 144 is configured to determine an image coordinate for each landmark point in the image and convert the image coordinate to a vehicle coordinate relative to the motor vehicle 100.

At block 206, the processor 144 executes the detection module 154 for determining the shape of the parking slot 120 and the range of parking slot angles based on the shape. The range of parking slot angles is indicated in an angle reference lookup table that is stored in the CRM 146.

At block 208, the processor 144 executes the estimate slot module 156 for determining at least three reference lines, with each reference line extending between each landmark point and an associated one of the other landmark points. Continuing with the previous example, at least two of the reference lines intersects one another. However, in another example where the processor detects four landmark points, four pairs of reference lines can intersect one another.

At block 210, the processor 144 executes the estimate slot module 156 for determining a tilt of each reference line and an angle that spaces each pair of intersecting reference lines. In this example where three landmark points 114, 116, 118 are detected and three reference lines 160, 162, 164 are determined, the processor 144 executes the estimate slot module 156 for determining a tilt of each of the reference lines according to Equations 1, 2, and 3 above.

At block 212, the processor 144 executes the estimate slot module 156 for comparing the angle between a pair of intersecting reference lines to the range of parking slot angles. If the processor 144 determines that the angle is within the range of parking slot angles, the process 200 proceeds to block 214. If the processor 144 determines that the angle is not within the range of parking slot angles, the process 200 proceeds immediately to block 220.

At block 214, the processor 144 executes the estimate slot module 156 for determining a distance between each landmark point and an associated one of the other landmark points.

At block 216, the processor 144 executes the estimate slot module 156 for comparing the distance to a range of parking slot dimensions. If the processor 144 determines that the distance is within the range of parking slot dimensions, the process proceeds to block 218. If the processor 144 determines that the distance is not within the range of parking slot dimensions, the method proceeds to block 220.

At block 218, the processor 144 executes the estimate slot module 156 for determining that the landmark point, where the two associated reference lines intersect one another, is a corner of the parking slot.

At block 220, the processor 144 determines whether all angles have been compared to the range of parking slot angles and whether all distances have been compared to the range of parking slot dimensions. If the processor 144 determines that all angles have been compared to the range of parking slot angles and all distances have been compared to the range of parking slot dimensions, the process 200 proceeds to block 222. If the processor 144 determines that all angles have not been compared to the range of parking slot angles and all distances have been not compared to the range of parking slot dimensions, the process 200 returns to block 212 to analyze the remaining angles and distances.

At block 222, the processor 144 executes the maneuver module 172 for generating one or more action signals to maneuver the motor vehicle 100 into the parking slot 120 based on the corners 158.

At block 224, the power steering system 174 steers the motor vehicle 100 into the parking slot 120, in response to the power steering system 174 receiving the action signals from the processor 144.

In general, the computing systems and/or devices described may employ any of a number of computer operating systems, including, but by no means limited to, versions and/or varieties of the APPLINK/SMARTDEVICE LINK middleware, the WINDOWS EMBEDDED AUTOMOTIVE operating system, the WINDOWS AUTOMOTIVE operating system, the UNIX operating system (e.g., the SOLARIS operating system distributed by ORACLE CORPORATION of Redwood Shores, Calif.), the AIX UNIX operating system distributed by INTERNATIONAL BUSINESS MACHINES of Armonk, N.Y., the LINUX operating system, the MAC OSX and iOS operating systems distributed by APPLE Inc. of Cupertino, Calif., the BLACKBERRY OS distributed by BLACKBERRY, Ltd. of Waterloo, Canada, and the ANDROID operating system developed by GOOGLE, Inc. and the OPEN HANDSET ALLIANCE, or the QNX CAR Platform for Infotainment offered by QNX Software Systems. Examples of computing devices include, without limitation, an on board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, JAVA, C, C++, MATLAB, SIMULINK, STATEFLOW, VISUAL BASIC, JAVA SCRIPT, PERL, HTML, TENSORFLOW, PYTHON, PYTORCH, KERAS, etc. Some of these applications may be compiled and executed on a virtual machine, such as the JAVA virtual machine, the DALVIK virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

The CRM (also referred to as a processor readable medium) participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An Automated Parking System for a motor vehicle, the Automated Parking System comprising:
a plurality of cameras mounted to the motor vehicle for generating a plurality of vision signals in response to the cameras capturing a plurality of images of an associated plurality of regions surrounding the motor vehicle;
at least one processor electrically connected to the cameras for receiving the associated vision signals;
a non-transitory computer readable storage medium electrically connected to the at least one processor and storing instructions such that the at least one processor is programmed to:
execute a plurality of routines including:
a detection module of a trained deep neural network, which when executed by the at least one processor, detects at least one landmark point in at least one of the images;
an estimate slot module, which when executed by the at least one processor, determines at least one corner associated with a parking slot based on the at least one landmark point; and
a maneuver module, which when executed by the at least one processor, generates at least one action signal to maneuver the motor vehicle into the parking slot based on the at least one corner; and
a power steering system electrically connected to the at least one processor and steering the motor vehicle into the parking slot in response to the power steering system receiving the action signal from the processor.

2. The Automated Parking System of claim 1, wherein the detection module, which when executed by the at least one processor, detects at least three of the at least one landmark point, and the estimate slot module, which when executed by the at least one processor:
determines at least three reference lines, with each of the reference lines extending between each one of the landmark points and an associated one of the other landmark points, and at least two of the reference lines intersect one another;
determines a tilt of each of the reference lines and an angle that spaces each pair of the reference lines that intersect one another;
compares the angle to a range of parking slot angles; and
determines that the associated landmark point where two of the reference lines intersect one another comprises a corner of a parking slot in response to the at least one processor determining that the angle associated with the landmark point is within the range of parking slot angles.

3. The Automated Parking System of claim 2, wherein the detection module, which when executed by the at least one processor:
determines a shape of the parking slot; and
determines the range of parking slot angles based on the shape, and the range of parking slot angles is indicated in an angle reference lookup table that is stored in the non-transitory computer readable storage medium.

4. The Automated Parking System of claim 3, wherein the angle reference lookup table indicates that the range of parking slot angles is between 40 and 65 degrees and between 115 and 140 degrees in response to the at least one processor determining that the shape of the parking slot is a parallelogram.

5. The Automated Parking System of claim 3, wherein the angle reference lookup table indicates that the range of parking slot angles is between 85 and 95 degrees in response to the at least one processor determining that the shape of the parking slot is a rectangle.

6. The Automated Parking System of claim 3, wherein the estimate slot module, which when executed by the at least one processor:
determines a distance between each one of the landmark points and an associated one of the other landmark points;
compares the distance to a range of parking slot dimensions, with the range of parking slot dimensions being indicated in a distance reference lookup table that is stored in the non-transitory computer readable storage medium; and
determines that the landmark point where two of the reference lines intersect one another comprises a corner of the parking slot in further response to the at least one processor determining that the distance is within the range of parking slot dimensions.

7. The Automated Parking System of claim 6, wherein the at least one processor is configured to:
determine an image coordinate for each of the landmark points in the image; and
convert the image coordinate to a vehicle coordinate relative to the motor vehicle.

8. The Automated Parking System of claim 7, wherein the maneuver module, which when executed by the at least one processor, generates the at least one action signal based on the vehicle coordinate.

9. A non-transitory computer readable storage medium for an Automated Parking System of a motor vehicle, with the non-transitory computer readable storage medium electrically connected to at least one processor and storing instructions such that the at least one processor is programmed to:
execute a plurality of routines including:
a detection module of a trained deep neural network, which when executed by the at least one processor, detects at least one landmark point in at least one of image of an associated plurality of regions surrounding the motor vehicle, with the at least one image being captured by a plurality of cameras mounted to the motor vehicle, and the cameras generating a plurality of vision signals in response to the cameras capturing a plurality of images;
an estimate slot module, which when executed by the at least one processor, determines at least one corner associated with a parking slot based on the at least one landmark point; and
a maneuver module, which when executed by the at least one processor, generates at least one action signal to maneuver the motor vehicle into the parking slot based on the at least one corner.

10. The non-transitory computer readable storage medium of claim 9, wherein the detection module, which when executed by the at least one processor, detects at least three of the at least one landmark point, and the estimate slot module, which when executed by the at least one processor:
determines at least three reference lines, with each of the reference lines extending between each one of the landmark points and an associated one of the other landmark points, and at least two of the reference lines intersect one another;
determines a tilt of each of the reference lines and an angle that spaces each pair of the reference lines that intersect one another;
compares the angle to a range of parking slot angles; and
determines that the associated landmark point where two of the reference lines intersect one another comprises a corner of a parking slot in response to the at least one processor determining that the angle associated with the landmark point is within the range of parking slot angles.

11. The non-transitory computer readable storage medium of claim 10, wherein the detection module, which when executed by the at least one processor:
determines a shape of the parking slot; and
determines the range of parking slot angles based on the shape, and the range of parking slot angles is indicated in an angle reference lookup table that is stored in the non-transitory computer readable storage medium.

12. The non-transitory computer readable storage medium of claim 11, wherein the angle reference lookup table indicates that the range of parking slot angles is between 40 and 65 degrees and between 115 and 140 degrees in response to the at least one processor determining that the shape of the parking slot is a parallelogram.

13. The non-transitory computer readable storage medium of claim 11, wherein the angle reference lookup table indicates that the range of parking slot angles is between 85 and 95 degrees in response to the at least one processor determining that the shape of the parking slot is a rectangle.

14. The non-transitory computer readable storage medium of claim 11, wherein the estimate slot module, which when executed by the at least one processor:
determines a distance between each one of the landmark points and an associated one of the other landmark points;
compares the distance to a range of parking slot dimensions, with the range of parking slot dimensions being indicated in a distance reference lookup table that is stored in the non-transitory computer readable storage medium; and
determines that the landmark point where two of the reference lines intersect one another comprises a corner of the parking slot in further response to the at least one processor determining that the distance is within the range of parking slot dimensions.

15. The non-transitory computer readable storage medium of claim 14, wherein the at least one processor is configured to:
determine an image coordinate for each of the landmark points in the image; and
convert the image coordinate to a vehicle coordinate relative to the motor vehicle.

16. The non-transitory computer readable storage medium of claim 15, wherein the maneuver module, which when executed by the at least one processor, generates the at least one action signal based on the vehicle coordinate.

17. A process of operating an Automated Parking System for a motor vehicle, with the Automated Parking System having a plurality of cameras mounted to the motor vehicle and a non-transitory computer readable storage medium electrically connected to at least one processor and storing instructions, the process comprising:
generating, using the plurality of cameras, a plurality of vision signals in response to the cameras capturing a plurality of images of an associated plurality of regions surrounding the motor vehicle;
receiving, by the at least one processor, the vision signals from the associated cameras;
detecting, using a detection module executed by the at least one processor, at least one landmark point in at least one of the images;
determining, using an estimate slot module executed by the at least one processor, at least one corner associated with a parking slot based on the at least one landmark point;
generating, using a maneuver module executed by the at least one processor, at least one action signal to maneuver the motor vehicle into the parking slot based on the at least one corner; and
steering, using a power steering system, the motor vehicle into the parking slot in response to the power steering system receiving the action signal from the processor.

18. The process of claim 17 further comprising:
detecting, using the detection module when executed by the at least one processor, at least three of the at least one landmark point;
determining, using the estimate slot module when executed by the at least one processor, at least three reference lines, and each of the reference lines extends between each one of the landmark points and an associated one of the other landmark points, and at least two of the reference lines intersect one another;
determining, using the estimate slot module when executed by the at least one processor, a tilt of each of the reference lines and an angle that spaces each pair of the reference lines that intersect one another;
comparing, using the estimate slot module when executed by the at least one processor, the angle to a range of parking slot angles; and
determining, using the estimate slot module when executed by the at least one processor, that the associated landmark point where two of the reference lines intersect one another comprises a corner of a parking slot in response to the at least one processor determining that the angle associated with the landmark point is within the range of parking slot angles.

19. The process of claim 18 further comprising:
determining, using the detection module executed by the at least one processor, a shape of the parking slot; and
determining, using the detection module executed by the at least one processor, the range of parking slot angles based on the shape, with the range of parking slot angles being indicated in an angle reference lookup table that is stored in the non-transitory computer readable storage medium.

20. The process of claim 19 further comprising:
determining, using the estimate slot module when executed by the at least one processor, a distance between each one of the landmark points and an associated one of the other landmark points;
comparing, using the estimate slot module when executed by the at least one processor, the distance to a range of parking slot dimensions, with the range of parking slot dimensions being indicated in a distance reference lookup table that is stored in the non-transitory computer readable storage medium; and
determining, using the estimate slot module when executed by the at least one processor, that the landmark point where two of the reference lines intersect one another comprises a corner of the parking slot in further response to the at least one processor determining that the distance is within the range of parking slot dimensions.
